(19) United States
(12) Patent Application Publication
(10) Pub. No.: US 2006/0158114 A1
(43) Pub. Date: Jul. 20, 2006

(54) Plasma display panel including a display filter having a black peripheral portion formed using a black treatment layer and method of fabricating the same

(75) Inventors: Dong-Gun Moon, Suwon-si (KR); Myun-Gi Shim, Suwon-si (KR); Ik-Chul Lim, Suwon-si (KR)

Correspondence Address: LEE & MORSE, P.C.;Attorney and Counselors At Law, SUITE 2000, 1101 WILSON BOULEVARD, ARLINGTON, VA, 22209, US

(73) Assignee: Samsung SDI Co., Ltd.

(21) Appl. No.: 11/319,782

(22) Filed: Dec. 29, 2005

(30) Foreign Application Priority Data
Dec. 30, 2004 (KR) 10-2004-0116912

(51) Int. Cl. H01J 17/49

(52) U.S. Cl. 313/582; 313/110; 313/586

(57) ABSTRACT

A plasma display panel having a display filter having a black peripheral portion, the black peripheral portion formed from a black treatment layer that includes a black material and a polymer composition, and a method of manufacturing the same.

### BACKGROUND OF THE INVENTION

1. Field of the Invention

The present invention relates to a plasma display panel. More particularly, the present invention relates to a plasma display panel including a display filter having a black peripheral portion formed using a black treatment layer and method of fabricating the same, which is capable of shielding electromagnetic radiation and improving color purity and contrast.

2. Description of the Related Art

Generally, plasma display panels are thin emissive display devices that can be easily manufactured in large sizes, and thus are particularly suited for high quality digital televisions. Despite the generally high quality of the images generated by plasma display panels, plasma display panels may exhibit undesirable qualities such as degradation of color purity and contrast due to electromagnetic radiation generated by plasma emission and various circuits, and due to near-infrared light generated by the inert gas plasma, used to emit light, in the plasma display panel.

A filter may be installed on a front portion of the plasma display panel in order to prevent the plasma display panel from emitting harmful electromagnetic radiation and near-infrared light, which may reduce the chances of causing sensitive electronic equipment to malfunction. The filter may also reduce surface reflection and improve color purity and contrast.

Some conventional filters used in plasma display panels are fabricated by forming a conductive layer or a metal mesh on a transparent glass or plastic substrate, the conductive layer reducing the emission of undesirable electromagnetic radiation, and stacking a film thereon, the film shielding near-infrared light and preventing reflections. Electric charges generated on the conductive layer or the metal mesh may be grounded through the chassis of the plasma display device.

FIG. 1 illustrates a cross-sectional view of a conventional plasma display panel and display filter. Referring to FIG. 1, the display filter 11 is installed on a front portion of the plasma display panel and a driving circuit 10. The filter 11 may include a substrate 12, which may be formed from, e.g., glass or plastic. A reflection prevention layer 13 may be disposed on the substrate 12 to suppress the reflection of external light that impinges on the surface of the filter 11.

The filter 11 may also include an electromagnetic radiation shielding layer 14 and a selective absorption layer 15 sequentially stacked under the substrate 12. The electromagnetic radiation shielding layer 14 may be formed from a conductive layer, a metal mesh, etc., and may shield electromagnetic radiation such as that generated within the plasma display panel. The electromagnetic radiation shielding layer 14 may be electrically grounded to the plasma display panel chassis and/or case 16.

The selective absorption layer 15 may shield and selectively absorb near-infrared light, such as that generated within the plasma display panel discharge cells. The plasma display panel and driving circuit 10 and the filter 11 may be accommodated in the case 16.

Filters for flat panel displays such as plasma displays may also include a black peripheral portion that serves to prevent glass from scattering if the panel is broken, as well as to improve the visual characteristics and contrast of the display. FIGS. 2 and 3 illustrate plan and cross-sectional views, respectively, of details of a conventional display filter 20 having a black peripheral portion 24.

Referring to FIGS. 2 and 3, the filter 20 may include a substrate 23, which may be formed of, e.g., glass or plastic. The filter may also include a reflection prevention layer 21 and a selective absorption layer 22, which may be disposed on a front surface of the substrate 23, as well as a black peripheral portion 24 and an electromagnetic radiation shielding layer 25, which may be disposed on a rear surface of the substrate 23. The reflection prevention layer 21, the selective absorption layer 22 and the electromagnetic radiation shielding layer 25 may be substantially similar to those described above in connection with FIG. 1. The black peripheral portion 24 may be disposed on edges of the substrate 23. The black peripheral portion 24 may be formed from, e.g., a black ceramic.

In manufacturing a conventional display filter having a black peripheral portion 24 that is formed from black ceramic, the filter may be thermally treated at a temperature of 500° C. or higher after applying the black ceramic to the substrate 23. Due to the high temperatures required for this heat treatment, this method is not suitable for direct-attaching type display filters that include films.

### SUMMARY OF THE INVENTION

The present invention is therefore directed to a plasma display panel including a display filter having a black peripheral portion formed using a black treatment layer and method of fabricating the same, which substantially overcome one or more of the problems due to the limitations and disadvantages of the related art.

It is therefore a feature of an embodiment of the present invention to provide a plasma display panel with a filter having a black treatment layer capable of shielding electromagnetic radiation and improving color purity and contrast.

It is therefore another feature of an embodiment of the present invention to provide a black treatment layer capable of being easily applied to a direct-attaching type film filter.

It is therefore yet another feature of an embodiment of the present invention to provide a method of fabricating the display filter.

At least one of the above and other features and advantages of the present invention may be realized by providing a plasma display panel including a front substrate, a rear substrate disposed parallel to the front substrate, a display filter having a black peripheral portion that includes a black material and a polymer composition, the display filter disposed adjacent to the front substrate, barrier ribs disposed between the front substrate and the rear substrate to define discharge cells, address electrodes extending adjacent to the discharge cells, the address electrodes arranged in a first direction and embedded in a rear dielectric layer, a phosphor layer disposed in the discharge cells, pairs of sustain electrodes extending in a second direction crossing the direction and embedded in a front dielectric layer, and a discharge gas in the discharge cells.

The polymer composition may be polymerizable by light or heat, and may include polyurethane oligomer, methacrylic acid, acrylic acid, photo initiator, and silica gel. The black peripheral portion may include about 1 to 10 parts by weight of the black material with respect to 100 parts by weight of the polymer composition. The polymer composition may include about 50 to about 90 parts by weight of the methacrylic acid, about 0.5 to about 10 parts by weight of the acrylic acid, about 0.5 to about 10 parts by weight of the photo initiator, and about 0.1 to about 15 parts by weight of the silica gel, with respect to 100 parts by weight of the polyurethane oligomer. The polymer composition may include about 60 to about 80 parts by weight of the methacrylic acid, about 1 to about 10 parts by weight of the acrylic acid, about 1 to about 5 parts by weight of photo initiator, and about 1 to about 10 parts by weight of the silica gel with respect to 100 parts by weight of the polyurethane oligomer. The black material may be selected from the group consisting essentially of TiO, CuO, NiO, MnO₂, Cr₂O₃, Fe₂O₃, carbon black, and combinations thereof. The black peripheral portion may be formed to a thickness of about 5 to about 50 μm. A width of the black peripheral portion may be about 10 to about 50 mm.

At least one of the above and other features and advantages of the present invention may also be realized by providing a display filter including a black peripheral portion, wherein the black peripheral portion is formed of a black treatment layer that includes a black material and a polymer composition.

The display filter may further include a transparent substrate having a first surface on which the black peripheral portion is formed, and an electromagnetic shielding layer disposed on the transparent substrate and on the black peripheral portion. The display filter may further include a selective absorption layer and a reflection prevention layer disposed on a second surface of the transparent substrate. The black material may be selected from the group consisting essentially of TiO, CuO, NiO, MnO₂, Cr₂O₃, Fe₂O₃, carbon black, and combinations thereof. The polymer composition may be polymerizable by light or heat, and may include polyurethane oligomer, methacrylic acid, acrylic acid, photo initiator, and silica gel. The black treatment layer may include from about 1 to about 10 parts by weight of the black material with respect to 100 parts by weight of the polymer composition.

At least one of the above and other features and advantages of the present invention may further be realized by providing a black treatment layer including a black material and a polymer composition, the polymer composition being polymerizable by light or heat.

The polymer composition may include polyurethane oligomer, methacrylic acid, acrylic acid, photo initiator, and silica gel. A ratio of the black material to the polymer composition may be in the range of about 1:100 to about 10:100 parts by weight. The black material may be selected from the group consisting essentially of TiO, CuO, NiO, MnO₂, Cr₂O₃, Fe₂O₃, carbon black, and combinations thereof.

At least one of the above and other features and advantages of the present invention may additionally be realized by providing a method of fabricating a display filter, the method including forming a black peripheral portion by stacking and polymerizing a black treatment layer on a surface of a transparent substrate, the black treatment layer disposed along a peripheral portion of the transparent substrate, wherein the black treatment layer may include a black material and a polymer composition, the polymer composition being polymerizable by light or heat. The polymer composition may be polymerizable by light and polymerizing includes irradiating ultraviolet light having an energy of about 100 to about 1000 mJ onto the black treatment layer for about 5 to about 30 seconds.

### BRIEF DESCRIPTION OF THE DRAWINGS

The above and other features and advantages of the present invention will become more apparent to those of ordinary skill in the art by describing in detail exemplary embodiments thereof with reference to the attached drawings in which:

FIG. 1 illustrates a schematic cross-sectional view of a conventional plasma display panel including a display filter;

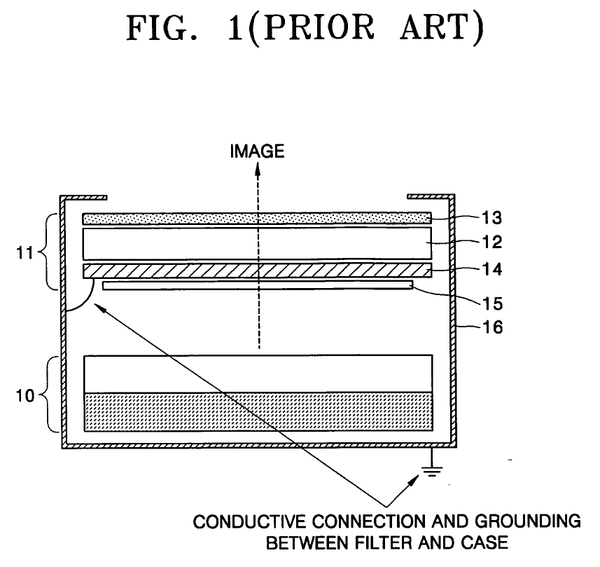

FIGS. 2 and 3 illustrate plan and cross-sectional views, respectively, of details of a conventional display filter having a black peripheral portion; and

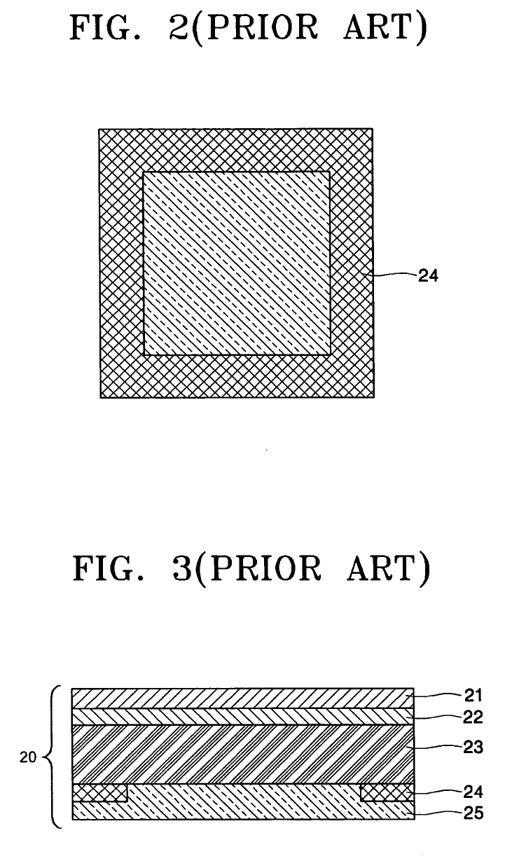

FIG. 4 illustrates a partial perspective view of a plasma display panel including a display filter according to an embodiment of the present invention.

### DETAILED DESCRIPTION OF THE INVENTION

Korean Patent Application No. 10-2004-0116912, filed on Dec. 30, 2004, in the Korean Intellectual Property Office, and entitled: “Black Treatment Layer, Display Filter Having Black Peripheral Portion Formed Using the Black Treatment Layer, Method of Fabricating the Display Filter, and Plasma Display Panel Including the Display Filter,” is incorporated by reference herein in its entirety.

The present invention will now be described more fully hereinafter with reference to the accompanying drawings, in which exemplary embodiments of the invention are shown. The invention may, however, be embodied in different forms and should not be construed as limited to the embodiments set forth herein. Rather, these embodiments are provided so that this disclosure will be thorough and complete, and will fully convey the scope of the invention to those skilled in the art. In the figures, the dimensions of layers and regions are exaggerated for clarity of illustration. It will also be understood that when a layer is referred to as being “on” another layer or substrate, it can be directly on the other layer or substrate, or intervening layers may also be present. Further, it will be understood that when a layer is referred to as being “under” another layer, it can be directly under, and one or more intervening layers may also be present. In addition, it will also be understood that when a layer is referred to as being “between” two layers, it can be the only layer between the two layers, or one or more intervening layers may also be present. Like reference numerals refer to like elements throughout.

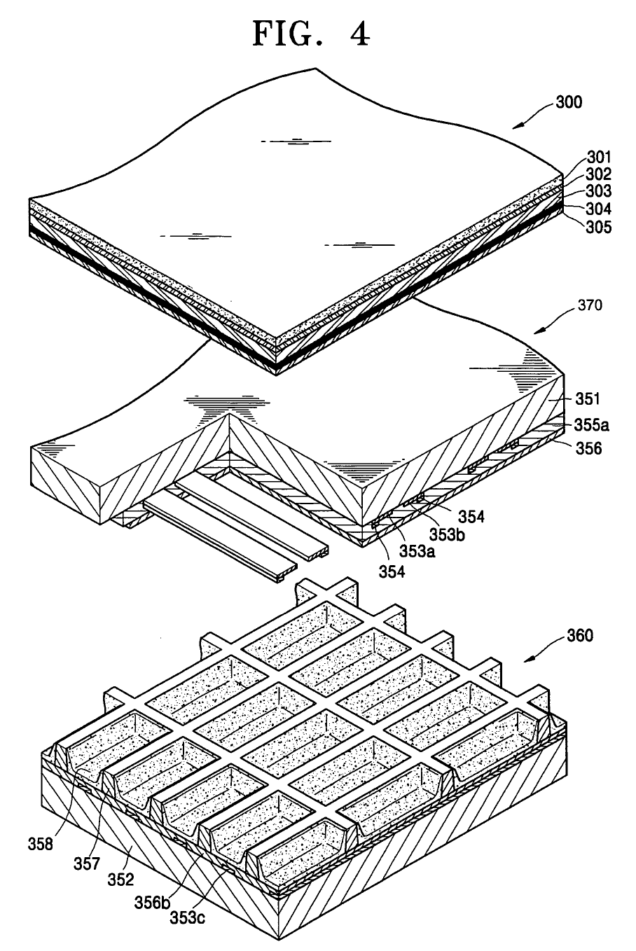

FIG. 4 illustrates a partial perspective view of a plasma display panel including a display filter according to an embodiment of the present invention. Referring to FIG. 4, the plasma display panel may include a front panel 370 and a rear panel 360. The rear panel 360 may be disposed parallel to the front panel 370 and may be separated therefrom by a predetermined distance. The plasma display panel may also include a display filter 300, which may be disposed adjacent to the front panel 370.

The front panel 370 may include a front substrate 351 and pairs of sustain electrodes, each of which includes an X electrode and a Y electrode, formed on a rear surface of the front substrate 351. The X and Y electrodes may include transparent electrodes 353a and 353b, respectively, which may be formed of, e.g., indium tin oxide (ITO), and bus electrodes 354, which may be formed of, e.g., a metal having high conductivity. The front panel 370 may also include a front dielectric layer 355a covering the pairs of sustain electrodes, and a protective layer 356 covering the front dielectric layer 355a.

The rear panel 360 may include a rear substrate 352 and address electrodes 353c formed on a front surface of the rear substrate 352. The address electrodes 353c may be disposed so as to cross the pairs of sustain electrodes on the front panel 370. The rear panel 360 may also include a rear dielectric layer 356b covering the address electrodes 353c and barrier ribs 357 formed on the rear dielectric layer 356b to define discharge cells that face the front panel 370. A phosphor layer 358 may be disposed in the discharge cells, and a discharge gas (not shown) may be introduced into the discharge cells upon assembly of the plasma display panel.

A display filter 300 may be disposed in front of the front panel 370. The display filter 300 according to the present invention may be, e.g., a direct-attaching type filter that includes films. Additionally, the display filter 300 according to the present invention may be used as a display filter for flat panel displays generally, and is not limited to use with plasma display panels.

The display filter 300 may include a substrate 303. A reflection prevention layer 301 and a selective absorption layer 302 may be disposed on a front surface of the substrate 303. Additionally, a black peripheral portion 304, formed of a black treatment layer, and an electromagnetic shielding layer 305 may be disposed on a rear surface of the substrate 303, adjacent to the front panel 370. This arrangement of layers is merely exemplary, however, and the present invention is not limited to the illustrated layer structure.

In detail, the substrate 303 may be formed of a transparent material, e.g., glass, polyethylene terephthalate (PET) film, triacetyl cellulose (TAC), polyvinyl alcohol (PVA), polyethylene, etc. The thickness of the transparent substrate may be in the range of about 10 to about 1000 μm.

The reflection prevention layer 301 may be stacked on the selective absorption layer 302, which may be stacked on the substrate 303. The reflection prevention layer 301 may be bonded to the selective absorption layer 302 using an adhesive layer (not shown). The adhesive layer may be formed of an adhesive agent, e.g., an acryl-based resin, a polyester resin, an epoxy resin, a urethane resin, etc. The thickness of the adhesive layer may be in the range of about 1 to about 100 μm.

The reflection prevention layer may prevent external light from being reflected, thereby reducing diffuse reflections that degrade display qualities by lowering display contrast. The reflection prevention layer may be formed as a single layer or as multiple layers including one or more materials having different refractive indexes, e.g., TiO₂, SiO₂, Y₂O₃, MgF₂, Na₃AlF₆, etc. The thickness of the reflection prevention layer may generally be in a range of about 10 to about 100 nm.

The selective absorption layer 302 may be bonded to the transparent substrate 303 by using, e.g., an adhesive layer (not shown). The selective absorption layer 302 may include a selective light absorption material, e.g., a tetraazaporphyrin compound, and may serve to improve color reproducibility by absorbing near-infrared light that originates within the discharge cells of the plasma display panel. The thickness of the selective absorption layer 302 may generally be in the range of about 1 to about 100 μm. If the thickness of the selective absorption layer 302 is less than about 1 μm, it may be difficult to coat the selective absorption layer so that it has an even thickness. Further, satisfactory color reproducibility may not be realized, since the near-infrared light absorption of such a thin layer may not be sufficient. In addition, if the thickness of the selective absorption layer 302 is greater than about 100 μm, air pores may be generated during post-processing and cracks may occur.

The black peripheral portion 303 and the electromagnetic radiation shielding layer may be disposed on, e.g., a rear surface of the transparent surface. The black peripheral portion 303 will be described in greater detail below. The electromagnetic radiation shielding layer 305 may be bonded to the substrate 303 using, e.g., an adhesive layer (not shown), and may shield electromagnetic radiation generated by the plasma display panel.

The electromagnetic radiation shielding layer 305 may be, e.g., a metal mesh, and may be formed of, e.g., Ag, Cu, Ni, Al, Au, Fe, In, Zn, Pt, Cr, Pd, etc. The electromagnetic radiation shielding layer 305 may have a multi-layered structure including one or more of the above materials. If the electromagnetic wave shielding layer 305 has a multi-layered structure, the thickness of the layer may be in the range of about 10 to about 500 nm. If the electromagnetic wave shielding layer 305 is formed as a metal mesh, the thickness of the layer may be in the range of about 1 to about 100 μm.

Exemplary embodiments of the black peripheral portion 304 according to the present invention will now be set forth in detail. The black peripheral portion 304 may be disposed along the edges of a surface of the substrate 303. The black peripheral portion 304 may be formed of a black treatment layer that is suitable for use in a direct-attaching type filter having films, unlike conventional display filters in which the black peripheral portion is formed of black ceramics. In particular, the black peripheral portion 304 may be formed of a black treatment layer that includes a black material and a polymer composition. Thus, the time required to manufacture the filter 300 may be reduced, and the filter 300 may be prepared without causing environmental problems due to usage of heavy metals, while at the same time enabling formation of a black peripheral portion 304 that is equivalent to a conventional black ceramic peripheral portion in other respects.

The thickness of the black peripheral portion 304 may be in the range of about 5 to about 50 μm. If the thickness of the black peripheral portion is less than about 5 μm, black color may not be represented completely, and if the thickness of the black peripheral portion is greater than about 50 μm, it may be difficult to attach the films after fabricating the filter, due to the differences between the thicknesses.

The width of the black peripheral portion may be in the range of about 10 to about 50 mm. If the width of the black peripheral portion 304 is less than about 10 mm, the black peripheral portion may not block non-emission regions, and if the width of the black peripheral portion 304 is greater than about 50 mm, the display region of the screen may be partially blocked by the black peripheral portion 304.

The black material may include one or more of, e.g., TiO, CuO, NiO, MnO₂, Cr₂O₃, Fe₂O₃, carbon black, etc. The polymer composition may be polymerizable by light or heat. The polymer composition may include, e.g., a polyurethane oligomer, methacrylic acid, acrylic acid, a photo initiator, and silica gel. The black treatment layer that makes up the black peripheral portion 304 may include, e.g., about 1 to about 10 parts by weight of the black material, with respect to 100 parts by weight of the polymer composition.

If the black material content of the black treatment layer is greater than the range described above, the black peripheral portion may not cure properly, and thus the physical properties of the black peripheral portion may be less than satisfactory. If the black material content is less than the range described above, the black efficiency may be degraded or the thickness of the black peripheral portion 304 may have to be increased to an undesirable degree.

In particular, the polymer composition may include about 50 to about 90 parts by weight of methacrylic acid, about 0.5 to about 10 parts by weight of acrylic acid, about 0.5 to about 10 parts by weight of photo initiator, and about 0.1 to about 15 parts by weight of silica gel (note that each range is given with respect to 100 parts by weight of the polyurethane oligomer). In an implementation, the polymer composition may include about 60 to about 80 parts by weight of methacrylic acid, about 1 to about 10 parts by weight of acrylic acid, about 1 to about 5 parts by weight of the photo initiator, and about 1 to about 10 parts by weight of the silica gel, with respect to 100 parts by weight of the polyurethane oligomer.

If the relative content of the polyurethane oligomer is less than the above range, the black peripheral portion 304 may not cure well, and if the content of the polyurethane oligomer exceeds the above range, the purity of the black color may degrade. If the content of methacrylic acid is less than the above range, the hardness of black peripheral portion 304 may be poor, and if the content of the methacrylic acid exceeds the above range, the black peripheral portion 304 may not cure. In addition, if the content of acrylic acid is less than the above range, the hardness of black peripheral portion 304 may be poor, and if the content of the acrylic acid exceeds the above range, the black peripheral portion 304 may not cure. Also, if the content of the photo initiator is less than the above range, the polymer may not cure even if it is irradiated with ultraviolet light, and if the content of the photo initiator exceeds the above range, air pores may be generated after a coating process. If the content of the silica gel is less than the above range, a brilliance of the black peripheral portion 304 may be degraded, and if the content of the silica gel exceeds the above range, the hardness of the black peripheral portion 304 may be degraded.

In an embodiment of the present invention, a method of fabricating a display filter may include disposing a black treatment layer along edges of a transparent substrate, on a surface of the transparent substrate, and photopolymerizing or thermopolymerizing the black treatment layer to form a black peripheral portion.

The photopolymerization or thermopolymerization may include irradiating ultraviolet light onto the black treatment layer. The ultraviolet light may have an energy of about 100 to about 1000 mJ, and the duration of irradiation may be in the range of about 5 to about 30 seconds

The black peripheral portion formed using ultraviolet light irradiation may be applied to a direct-attaching type display filter having films. In addition, the processing time of the photopolymerization may be less than that required for conventional methods that require heat treatment of black ceramic materials.

According to the present invention, the black treatment layer may be easily applied to a display filter that is similar to a conventional display filter in other respects, e.g., a direct-attaching type display filter, while shielding electromagnetic radiation and improving color purity and contrast. Also, processing time may be reduced, and environmental problems due to usage of heavy metals may be avoided.

Hereinafter, particular examples will be described in detail. However, the present invention is not limited to these examples.

### EXAMPLE 1

A glass substrate having a thickness of 125 μm was used as a transparent substrate. A selective absorption layer, on which a porphyrin-based pigment was coated, was attached to a surface of the glass substrate using an acryl-based resin as an adhesive material. A reflection prevention film having a thickness of 100 μm was attached on the selective absorption layer using the same adhesive material. The reflection prevention film was manufactured by Nippon Chemical Corp., and included a reflection prevention layer having a thickness of 300 nm.

A black treatment layer was applied to a thickness of 30 μm on a peripheral region of an opposing surface of the glass substrate. The black treatment layer included carbon black as the black color pigment, at about 1.5% by weight. A curing process was performed using ultraviolet light having an energy of 1000 mJ for 30 seconds. Finally, a mesh (line width 10 μm, pitch 300 μm) was attached to the surface of the opposing surface of the glass substrate (i.e., the surface having the black treatment layer thereon) to obtain the display filter of the present invention.

### EXAMPLE 2

The display filter Example 2 was fabricated like the display filter in Example 1, except that the black treatment layer included 3% by weight of carbon black as the black pigment.

### COMPARATIVE EXAMPLE 1

The first comparative display filter was fabricated like the display filter in Example 1, except without the black treatment layer. Instead of the black treatment layer, Comparative Example 1 had a black peripheral region formed only of carbon black (fabricated by SHC Corp.), which was heat-treated at a temperature of 450° C. for 30 minutes.

### COMPARATIVE EXAMPLE 2

The second comparative display filter was fabricated like the display filter in Example 1, again without the black treatment layer. Instead of the black treatment layer, Comparative Example 2 had a black peripheral region formed only of carbon black (fabricated by SHC Corp.), which was heat-treated at a temperature of 500° C. for 30 minutes.

### COMPARATIVE EXAMPLE 3

The third comparative display filter was fabricated like the display filter in Example 1, again without the black treatment layer. Instead of the black treatment layer, Comparative Example 2 had a black peripheral region formed only of carbon black (fabricated by SHC Corp.), which was heat-treated at a temperature of 550° C. for 30 minutes.

Color Coordinate Measurement Experiment

Color coordinates (L, a, b) of the display filters according to Examples 1 and 2, and Comparative Examples 1 through 3 were measured, and the measurement results are shown in Table 1.

In the present experiment, a chroma meter (Minolta CR-200) was used to measure the color coordinates, wherein “L” represents brightness, and “a” and “b” are coordinates representing colors (+a: red, −a: green, +b: yellow, and −b: blue).

TABLE 1

| | | | Com- | Com- | Com- |
|---|---|---|---|---|---|
| | | | parative | parative | parative |
| Color | Example | Example | Example | Example | Example |
| Coordinates | 1 | 2 | 1 | 2 | 3 |
| L | 23.45 | 20.14 | 37.28 | 24.34 | 21.16 |
| a | −0.5 | −0.19 | −1.08 | −0.3 | −0.39 |
| b | 0.45 | −0.09 | −2.42 | −0.47 | −0.38 |

Referring to Table 1, the L values of the display filters according to Examples 1 and 2 are 23.34 and 20.14. By comparison, the display filter of Comparative Example 1 exhibited an L value of the black color equal to 37.28, which means the represented color is more similar to grey color, rather than true black color. The L value of the display filter of Comparative Example 2 was 24.34, which represents a black color level lower than that of a conventionally used display filter. The display filter of Comparative Example 3 has an L value of 21.16, which is similar to the black level of a conventionally used display filter. Thus, it is evident that display filters according to the present invention may exhibit satisfactory color qualities, and may exhibit black color levels equal to, or superior to, black color levels of conventional display filters.

Exemplary embodiments of the present invention have been disclosed herein, and although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the present invention as set forth in the following claims.

What is claimed is:

1. A plasma display panel comprising:
a front substrate;
a rear substrate disposed parallel to the front substrate;
a display filter having a black peripheral portion that includes a black material and a polymer composition, the display filter disposed adjacent to the front substrate;
barrier ribs disposed between the front substrate and the rear substrate to define discharge cells;
address electrodes extending adjacent to the discharge cells, the address electrodes arranged in a first direction and embedded in a rear dielectric layer;
a phosphor layer disposed in the discharge cells;
pairs of sustain electrodes extending in a second direction crossing the direction and embedded in a front dielectric layer; and
a discharge gas in the discharge cells.

2. The plasma display panel as claimed in claim 1, wherein the polymer composition is polymerizable by light or heat, and includes polyurethane oligomer, methacrylic acid, acrylic acid, photo initiator, and silica gel.

3. The plasma display panel as claimed in claim 2, wherein the black peripheral portion includes about 1 to 10 parts by weight of the black material with respect to 100 parts by weight of the polymer composition.

4. The plasma display panel as claimed in claim 3, wherein the polymer composition includes about 50 to about 90 parts by weight of the methacrylic acid, about 0.5 to about 10 parts by weight of the acrylic acid, about 0.5 to about 10 parts by weight of the photo initiator, and about 0.1 to about 15 parts by weight of the silica gel, with respect to 100 parts by weight of the polyurethane oligomer.

5. The plasma display panel as claimed in claim 4, wherein the polymer composition includes about 60 to about 80 parts by weight of the methacrylic acid, about 1 to about 10 parts by weight of the acrylic acid, about 1 to about 5 parts by weight of photo initiator, and about 1 to about 10 parts by weight of the silica gel with respect to 100 parts by weight of the polyurethane oligomer.

6. The plasma display panel as claimed in claim 1, wherein the black material is selected from the group consisting essentially of TiO, CuO, NiO, MnO₂, Cr₂O₃, Fe₂O₃, carbon black, and combinations thereof.

7. The plasma display panel as claimed in claim 1, wherein the black peripheral portion is formed to a thickness of about 5 to about 50 μm.

8. The plasma display panel as claimed in claim 1, wherein a width of the black peripheral portion is about 10 to about 50 mm.

9. A display filter, comprising:
a black peripheral portion,
wherein the black peripheral portion is formed of a black treatment layer that includes a black material and a polymer composition.

10. The display filter as claimed in claim 9, further comprising:
a transparent substrate having a first surface on which the black peripheral portion is formed; and
an electromagnetic shielding layer disposed on the transparent substrate and on the black peripheral portion.

11. The display filter as claimed in claim 10, further comprising a selective absorption layer and a reflection prevention layer disposed on a second surface of the transparent substrate.

12. The display filter as claimed in claim 9, wherein the black material is selected from the group consisting essentially of TiO, CuO, NiO, MnO₂, Cr₂O₃, Fe₂O₃, carbon black, and combinations thereof.

13. The display filter as claimed in claim 9, wherein the polymer composition is polymerizable by light or heat, and includes polyurethane oligomer, methacrylic acid, acrylic acid, photo initiator, and silica gel.

14. The display filter as claimed in claim 13, wherein the black treatment layer includes from about 1 to about 10 parts by weight of the black material with respect to 100 parts by weight of the polymer composition.

15. A black treatment layer comprising:
a black material; and
a polymer composition, the polymer composition being polymerizable by light or heat.

16. The black treatment layer as claimed in claim 15, wherein the polymer composition includes polyurethane oligomer, methacrylic acid, acrylic acid, photo initiator, and silica gel.

17. The black treatment layer as claimed in claim 16, wherein a ratio of the black material to the polymer composition is in the range of about 1:100 to about 10:100 parts by weight.

18. The black treatment layer as claimed in claim 15, wherein the black material is selected from the group consisting essentially of TiO, CuO, NiO, MnO₂, Cr₂O₃, Fe₂O₃, carbon black, and combinations thereof.

19. A method of fabricating a display filter, the method comprising:
forming a black peripheral portion by stacking and polymerizing a black treatment layer on a surface of a transparent substrate, the black treatment layer disposed along a peripheral portion of the transparent substrate, wherein the black treatment layer includes:
a black material; and
a polymer composition, the polymer composition being polymerizable by light or heat.

20. The method as claimed in claim 19, wherein the polymer composition is polymerizable by light and polymerizing includes irradiating ultraviolet light having an energy of about 100 to about 1000 mJ onto the black treatment layer for about 5 to about 30 seconds.
